(19) United States
(12) Patent Application Publication
(10) Pub. No.: US 2025/0153336 A1
(43) Pub. Date: May 15, 2025

(54) Method for controlling a charging apparatus

(71) Applicant: Hilti Aktiengesellschaft, Schaan (LI)

(72) Inventors: Suyog Pradip MAHAJAN, Augsburg (DE); Florian HURKA, Margertshausen (DE)

(21) Appl. No.: 18/992,727

(22) PCT Filed: Jul. 13, 2023
(86) PCT No.: PCT/EP2023/069490

§ 371 Date: Jan. 9, 2025

(30) Foreign Application Priority Data
Aug. 1, 2022 (EP) 22188046.1

(51) Int. Cl. B25F 5/02; B23B 49/00

(52) U.S. Cl. CPC B25F 5/021; B23B 49/003

(57) ABSTRACT

Method for open-loop and closed-loop control of a power tool, wherein the power tool is connected to at least one acquisition apparatus, comprising the following method steps: acquisition of a first distance value by a sensor; inputting of at least one distance-of-travel value into the acquisition apparatus by an input device; adjustment of the power tool from a first operating mode having at least a first operating characteristic into a second operating mode having at least a second operating characteristic; acquisition of at least a second distance value within a predetermined period of time; transmission of at least one signal from the acquisition apparatus to the power tool in dependence on the acquired at least second distance value; and adjustment of the power tool from the second operating mode into a third operating mode having at least a third operating characteristic after a predetermined signal has been received.

The present invention relates to a method for open-loop and closed-loop control of a power tool, wherein the power tool is connected to at least one acquisition apparatus.

Moreover, the present invention relates to an acquisition apparatus for performing the method.

In addition, the present invention relates to a system containing a power tool and an acquisition apparatus for performing the method.

### BACKGROUND

Machine tools in the form of drilling devices (i.e. hammer drills, power drills or core drills) for producing cylindrical boreholes are widely known from the prior art. In addition to the correct diameter, the actual borehole depth is also very important when producing a borehole.

For measuring or acquiring the instantaneous borehole depth, there are, likewise according to the prior art, numerous apparatuses of different designs and with different functionalities. However, these existing apparatuses are inaccurate and therefore problematic in terms of handling.

### SUMMARY OF THE INVENTION

It is an object of the present invention to solve the problem described above.

The present invention provides a method for open-loop and closed-loop control of a power tool, wherein the power tool is connected to at least one acquisition apparatus.

According to the invention, the following method steps are provided
acquisition of a first distance value by at least one sensor of the acquisition apparatus;
inputting of at least one distance-of-travel value into the acquisition apparatus by an input device;
adjustment of the power tool from a first operating mode having at least a first operating characteristic value into a second operating mode having at least a second operating characteristic value;
acquisition of at least a second distance value within a predetermined period of time;
transmission of at least one signal from the acquisition apparatus to the power tool in dependence on the acquired at least second distance value; and
adjustment of the power tool from the second operating mode into a third operating mode having at least a third operating characteristic value after a predetermined signal has been received.

The at least one sensor of the acquisition apparatus can be based on a transit time measurement, for example an ultrasound measurement.

It is possible in particular that at least a first and second acquisition apparatus are present, wherein the at least first acquisition apparatus is able to acquire a first distance value and the at least second acquisition apparatus is able to acquire a second distance value at the same time. The first and second distance values do not have to be identical at the start of the drilling operation. The acquisition of at least a first and second distance value serves to acquire a spatial position of the power tool in relation to the workpiece to be machined. The greater the number of acquisition apparatuses provided at different positions of the housing of the power tool, the more accurate the determination of the spatial position of the power tool. If, during the continuous acquisition of distance values by the first and second acquisition apparatuses during the drilling operation, a predetermined difference value between the acquired distance values of the first acquisition apparatus and the acquired distance values of the second acquisition apparatus is determined by means of the control device of the power tool, the power tool can be adjusted from a first operating mode having at least a first operating characteristic value into a second operating mode having at least a second operating characteristic value. A skewed, that is to say non-orthogonal, orientation of the power tool relative to a workpiece that is being machined can thus be prevented.

According to an alternative embodiment, it can be possible that the adjustment of the power tool from the first operating mode having at least the first operating characteristic value into the second operating mode having at least the second operating characteristic value takes place in dependence on at least one characteristic value of a material that is to be machined. The first operating mode can be an activated state of the power tool. The first operating characteristic value can be a first rotation speed value of the drive (e.g. motor). The second operating mode can either also be an activated state or can be a deactivated state of the power tool. The second operating characteristic value can be a second rotation speed value of the drive, which is either less than or greater than the first rotation speed value. The second rotation speed value may also be zero, so that no torque is generated by the drive.

According to an advantageous embodiment, it can be possible that the adjustment of the power tool from the first operating mode having at least the first operating characteristic value into the second operating mode having at least the second operating characteristic value takes place in dependence on the length of the distance of travel. It is thus possible that the rotation speed is reduced to zero when a specific drilling depth (i.e. distance of travel) has been reached.

The first and/or second operating characteristic value can be a rotation speed or torque.

According to a further advantageous embodiment, it can be possible that the adjustment of the power tool from the first operating mode having at least the first operating characteristic value into the second operating mode having at least the second operating characteristic value takes place in dependence on a diameter of a borehole that is to be produced by the power tool. Thus, in a simple manner, a maximum rotation speed can be defined for the drive for a diameter of a drill bit or for a drill, or the rotation speed for the drive can be limited.

According to a further advantageous embodiment, it can be possible that the transmission of the at least one signal from the acquisition apparatus to the power tool in dependence on the acquired at least second distance value takes place either directly from the acquisition apparatus to the power tool or by means of an external apparatus. A specific drilling depth can thus be displayed to a user. The rotation speed of the drive can remain the same, can increase or can be reduced.

The external apparatus can be embodied in the form of a smartphone, a tablet or a smartwatch.

According to a further advantageous embodiment, it can be possible that the third operating mode corresponds to a deactivated state of the power tool. In the case of the third operating mode, the rotation speed value and/or the torque value can be equal to zero.

According to a further advantageous embodiment, it can be possible that a tool of the power tool is operated in a first rotation direction in the first and/or second operating mode and in a second rotation direction in the third operating mode. Removal of a drilling tool (e.g. drill bit) from a borehole after a specific drilling depth has been reached can thus be facilitated.

According to a further advantageous embodiment, it can be possible that the operating characteristic values of the power tool can be a rotation speed value or torque value.

The present invention also provides an acquisition apparatus for performing the method.

According to the invention, it is provided that at least one sensor, a control device, an interface device and a communication device are present.

According to an advantageous embodiment, it can be possible that at least one sensor, a control device, an interface device and a communication device are present.

The interface device can be embodied in the form of a suitable form-fitting and/or force-based connection, so as to establish a fixed or detachable connection of the acquisition apparatus to the power tool.

The communication device can be based on wireless and/or wired data transmission technology.

According to a further advantageous embodiment, it can be possible that the acquisition apparatus is able to be detachably connected to the power tool.

According to an alternative advantageous embodiment, it can be possible that the acquisition apparatus is fixedly connected to the power tool.

In addition, the present invention also provides a system containing a power tool and an acquisition apparatus for performing the method.

According to the invention, it is provided that the power tool contains at least one power tool interface and the acquisition apparatus contains at least one acquisition apparatus interface, wherein the power tool interface and the acquisition apparatus interface are able to be fixedly or detachably connected together.

Further advantages will become apparent from the following description of the figures. Various exemplary embodiments of the present invention are illustrated in the figures.

### BRIEF DESCRIPTION OF THE DRAWINGS

The figures, the description, and the claims contain numerous features in combination. A person skilled in the art will expediently also consider the features individually and combine them to produce useful further combinations.

In the figures:

FIG. 1 shows a side view of a power tool according to a first embodiment and an acquisition apparatus, connected to the power tool, according to a first embodiment at the start of a drilling operation on a workpiece;

FIG. 2 shows a side view of the acquisition apparatus, connected to the power tool, during or at the end of a drilling operation on the workpiece;

FIG. 3 shows another side view of the power tool and the acquisition apparatus according to the first embodiment, together with an apparatus;

FIG. 4 shows another side view of the power tool and the acquisition apparatus according to a second embodiment; and

FIG. 5 shows another side view of the power tool having a first and second acquisition apparatus.

### DETAILED DESCRIPTION

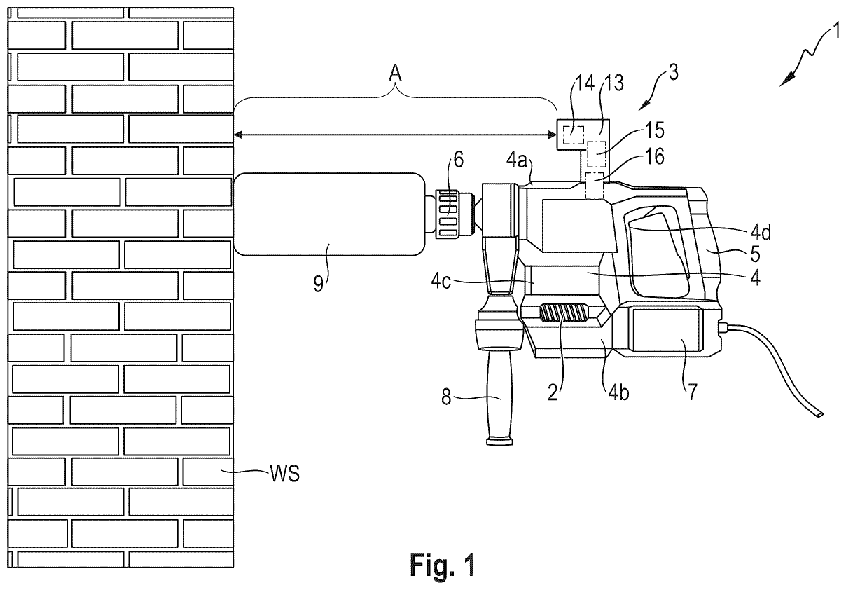

FIG. 1 shows a system 1 according to the invention consisting of a power tool 2 and an acquisition device 3 according to the invention.

The power tool 2 is embodied in the form of a hammer drill.

According to an alternative embodiment, the power tool 2 may also be embodied in the form of a power drill and a core drill.

The power tool 2 according to a first embodiment contains substantially a housing 4, a handle 5, a toolholder 6 and a power supply 7.

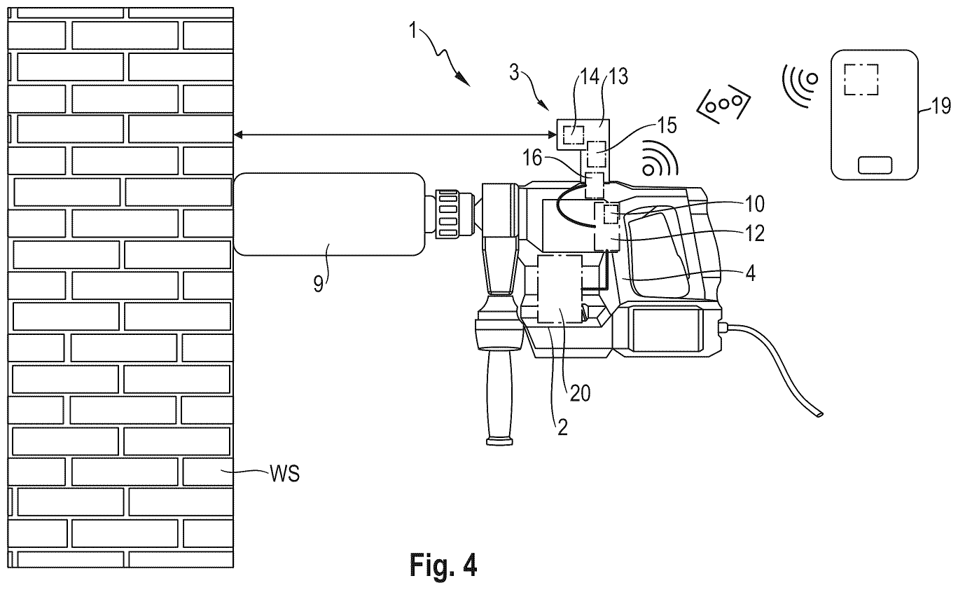

The housing 4 has an upper side 4a, a lower side 4b, a front end 4c, and a rear end 4d. In the interior of the housing 4 there is a drive 20 (see, e.g., FIG. 4), a transmission apparatus, a control apparatus 12 and a drive shaft. The control apparatus 12 is used for the open-loop and closed-loop control of the individual functions of the power tool 2 and is shown in FIG. 4.

The handle 5 is positioned at the rear end 4d of the housing 4 of the power tool 2 and is used to hold and guide the power tool 2. An auxiliary handle 8 for additionally holding and guiding the power tool 2 is also positioned at the front end of the housing 4c of the power tool 2.

The drive 20 is embodied in the form of a brushless electric motor and serves for generating a torque. The drive 20 is connected to the control apparatus 12, so that the control apparatus 12 is capable of closed-loop control of functions of the drive 20, such as, for example, the rotation speed and/or the torque.

Furthermore, the drive 20, the transmission apparatus, the control apparatus 12 and the drive shaft are so arranged in the interior of the housing 4 and relative to one another that the torque generated by the drive 20 can be transmitted to the transmission apparatus and the drive shaft. The toolholder 6 is positioned on the upper side 4a of the housing 4 and so arranged relative to the drive shaft that the torque is transmitted from the drive shaft to the toolholder 6. The toolholder 6 is used to receive and hold a tool 9. The tool 9 is embodied in the form of a drill bit in the figures.

The power supply 7 serves to supply the power tool 2, in particular the consumer of the power tool 2, with electrical energy and is embodied in the form of a mains connection. According to an alternative embodiment which is not shown in the figures, the power supply can also be embodied in the form of a rechargeable battery or a plurality of rechargeable batteries.

As can be seen in particular in FIG. 4, the power tool 2 according to a second embodiment can also contain a communication device 10, which is likewise positioned in the interior of the housing 4 of the power tool 2 and is connected to the control apparatus 12 by way of a corresponding line. By means of the connection of the control apparatus 12 to the communication device 10 of the power tool 2, data and values in the form of signals can be transmitted by the power tool 2. The communication device 10 of the power tool 2 is likewise embodied for sending and receiving data in the form of signals with an external apparatus 19. The communication device 10 of the power tool 2 is embodied in the present exemplary embodiment on the basis of Bluetooth technology.

Alternatively, the communication device 10 may also be based on WiFi, NFC (near field communication) or other suitable wireless data transmission technology.

Furthermore, the communication device 10 may also be based on wired data transmission technology.

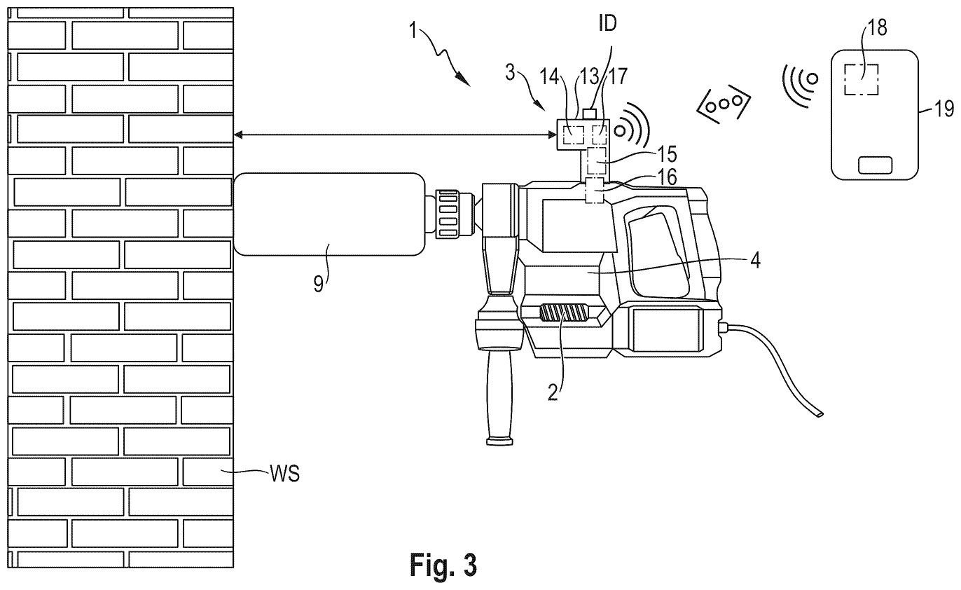

The acquisition apparatus 3 in the first embodiment shown in FIG. 3 essentially contains a housing 13, a sensor 14, a control device 15, an interface device 16, an input device and a communication device 17. The sensor 14, the control device 15 and the communication device 17 are positioned in the interior of the housing 13 of the acquisition apparatus 3. The interface device 16 is arranged on a lower side of the housing of the acquisition apparatus 3.

In the present exemplary embodiment, the sensor 14 is embodied in the form of an ultrasonic sensor and serves for measuring or acquiring distance values. The distance value may also be referred to as distance of travel, spacing or travel. Alternatively, the acquisition apparatus 3 can also contain more than one sensor 14. In the case where a plurality of sensors 14 are contained in the acquisition apparatus 3, the sensors 14 can all be the same type of sensor or alternatively can be different types of sensor.

The control device 15 serves for the open-loop and closed-loop control of the functions of the acquisition apparatus 3 and is connected to the sensor 14 by way of a corresponding line. The control device 15 is thus in particular configured such that data in the form of signals can be acquired by the sensor 14 and processed.

The communication device 17 of the acquisition apparatus 3 is connected to the control device 15 and serves for transmitting and receiving data in the form of signals. By means of the communication device 17, the acquisition apparatus 3 is able to communicate, that is to say exchange data and values in the form of signals, with an external apparatus 19. The external apparatus 19 can be the power tool 2, another power tool, a vacuum cleaner, a water supply or a smartphone.

In the present exemplary embodiment, the external apparatus 19 is embodied in the form of a smartphone. The communication device 17 of the acquisition apparatus is embodied in the present exemplary embodiment on the basis of Bluetooth technology. Alternatively, the communication device 17 may also be based on WiFi, NFC (near field communication) or other suitable wireless data transmission technology. Furthermore, the communication device 17 may also be based on wired data transmission technology.

The input device is used for inputting data into the acquisition apparatus 3 and is embodied in the form of an operator input field. The input device is shown in the figures solely schematically as ID. Alternatively, the input device may also be embodied by the external apparatus 19, so that a specific command or data is/are inputted into the external apparatus 19 (e.g. a smartphone) and received by the acquisition apparatus 3 by means of the communication device 17. For this purpose, the external apparatus 19 likewise has a communication device 18.

In the present exemplary embodiment, the interface device 16 is used for detachably connecting the acquisition apparatus 3 to the housing 4 of the power tool 2. To this end, the interface device 16 is designed with a screw connection. The screw connection is not shown in the figures.

Alternatively or in addition, the interface device 16 can also be embodied in the form of a rail apparatus, a snap-fit connection or a suitable form-fitting and/or force-based connection. The interface device 16 contains in particular an electrical connection with the control apparatus 12 of the power tool 2. By means of the electrical connection, data in the form of signals can be exchanged between the control device 15 of the acquisition apparatus 3 and the control apparatus 12 of the power tool 2. By way of the electrical connection, a stop signal, for example, can be transmitted from the control device 15 of the acquisition apparatus 3 to the control apparatus 12 of the power tool 2 when a specific distance value has been acquired by the sensor 14, so that the drive 20 of the power tool 2 is braked (i.e. slowed down) or stopped by the control apparatus 12.

For performing the method according to the invention for open-loop and closed-loop control of a power tool 2, a first distance value A is first acquired, as is shown in FIG. 1, by the sensor 14 of the acquisition apparatus 3. The acquired first distance value A corresponds to an initial distance of the sensor 14 from a material WS to be machined before work or drilling is started and is transmitted in the form of a signal to the control device 15 of the acquisition apparatus 3.

A distance value is then inputted into the acquisition apparatus 3 by way of the input device (shown in the figures as ID and/or 19). The distance value can be a desired borehole depth into the material WS which is to be achieved at the end of the drilling operation. The distance value is fed into the control device 15 of the acquisition apparatus 3, where it is stored by means of a memory. More than one distance value can be fed into the control device 15 of the acquisition apparatus 3 and stored in the memory.

In a following method step, the power tool 2 is adjusted from a first operating mode having at least a first operating characteristic value into a second operating mode having at least a second operating characteristic value. In the present exemplary embodiment, the operating characteristic value (also operating parameter) is a rotation speed of the drive 20 embodied in the form of an electric motor. The first rotation speed (i.e. the first operating characteristic value) is lower than the second rotation speed (i.e. the second operating characteristic value). The first rotation speed may also be zero, so that the power tool 2 is initially in a deactivated state.

A second distance value is further acquired by the sensor 14 within a predetermined period of time, or after a certain period of time. The period of time may be 10 seconds. It is possible that a distance value is acquired by the sensor 14 at time intervals of 2 to 5 seconds. The time intervals may be greater than or also less than 2 to 5 seconds.

The distance value or distance values acquired by the sensor 14 are transmitted in the form of a signal from the acquisition apparatus 3 to the power tool 2. The transmitted signal is dependent on or related to the distance value acquired in each case.

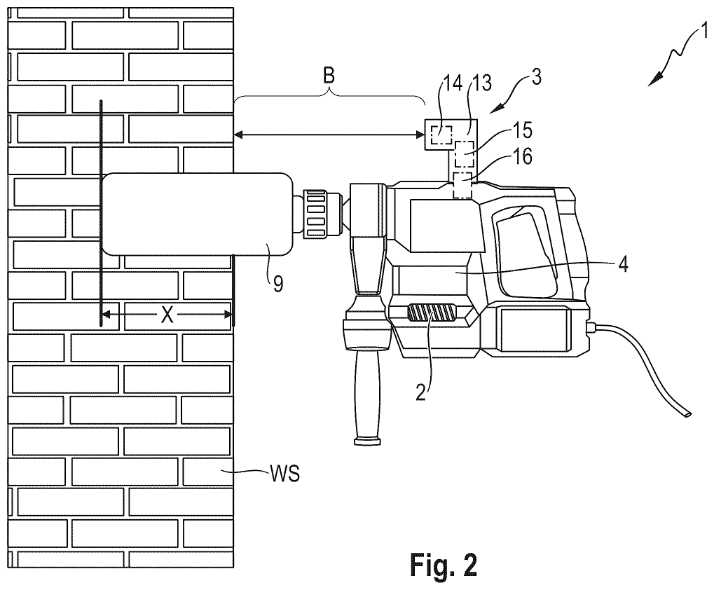

In a further method step, the power tool 2 is adjusted from the second operating mode into a third operating mode having at least a third operating characteristic value after a predetermined signal has been received by the communication device 10 of the power tool 2. The predetermined signal corresponds to a distance value B acquired by the sensor, which distance value corresponds to the desired or programmed borehole depth. The drilling operation is to be terminated, see FIG. 2.

The third operating characteristic value is a rotation speed that corresponds to zero. In other words: the third operating mode of the power tool 2 corresponds to a deactivated state in which the drive 20 no longer generates a rotation speed and consequently also no longer generates a torque. Alternatively, the third operating mode may be a state in which the drive 20 rotates in an opposite rotation direction than in the second operating mode. As a result, the tool 9 also rotates in an opposite rotation direction compared to the second operating mode. As a result of the opposite rotation direction of the tool 9 (i.e. of the drill), no further drilling operation (removal of material) takes place, or the borehole does not become any deeper. Furthermore, as a result of the operation of braking the drive 20 and also as a result of the rotation of the tool 9 in the opposite direction, it is relatively clearly indicated to a user of the power tool 2 that the desired or programmed borehole depth B has been reached.

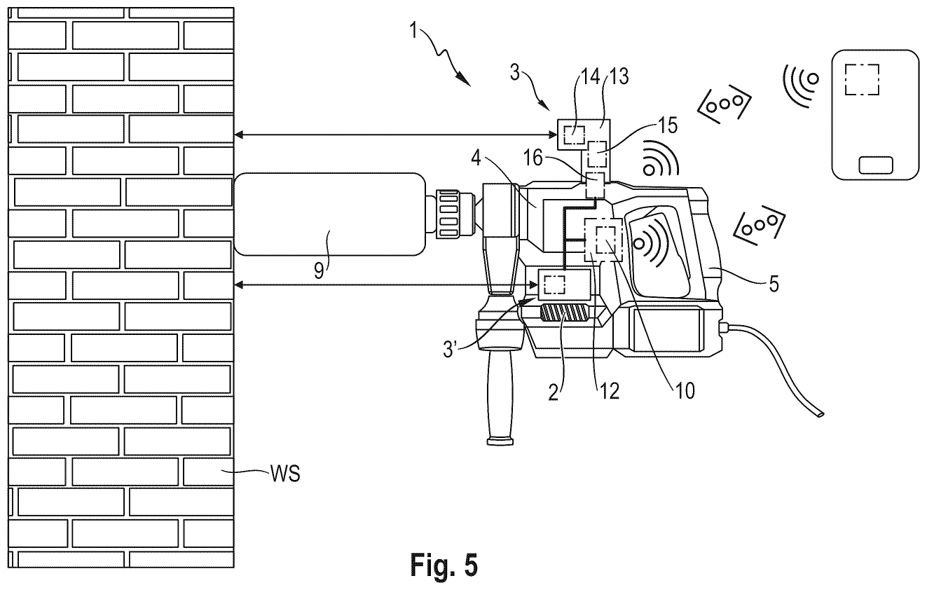

FIG. 5 shows another embodiment of the power tool 2 with a first and second acquisition apparatus 3, 3′. The two acquisition apparatuses 3, 3′ are embodied substantially identically or with an identical construction. The two acquisition apparatuses 3, 3′ each acquire a distance value. The first and second acquisition apparatuses 3, 3′ are in communication with one another as well as in each case with the control device 12 of the power tool 2, so that data and values in the form of signals can be transmitted and received between the two acquisition apparatuses 3, 3′ and from each acquisition apparatus 3 to the control device 12 of the power tool 2. As a result of the simultaneous acquisition of first distance values by the first acquisition apparatus 3 and of second distance values by the second acquisition apparatus 3′, the spatial position, that is to say the position of the power tool 2 relative to the workpiece WS to be machined, can be determined. In the event of a deviation by a predetermined threshold value (e.g. more than 5° in an x-, y- or z-axis), the control device 12 of the power tool 2 can stop the drive 20 or transmit a corresponding warning signal to the power tool 2 or to the external apparatus 19 by way of an output device (not shown in the figures).

### LIST OF REFERENCE SIGNS

1 System
2 Machine tool
3, 3′ Acquisition apparatus
4 Housing of the power tool
4a Upper side of the housing of the power tool
4b Lower side of the housing of the power tool
4c Front end of the housing of the power tool
4d Rear end of the housing of the power tool
5 Handle
6 Toolholder
7 Power supply
8 Auxiliary handle
9 Tool
10 Communication device of the power tool
12 Control device of the power tool
13 Housing of the acquisition apparatus
14 Sensor of the acquisition apparatus
15 Control device of the acquisition apparatus
16 Interface device of the acquisition apparatus
17 Communication device of the acquisition apparatus
18 Communication device of the external apparatus
19 External apparatus
20 Drive
WS Material

1-12. (canceled)

13: A method for open-loop or closed-loop control of a power tool, the power tool being connected to at least one acquisition apparatus, the method comprising the following steps:
acquisition of a first distance value by at least one sensor of the acquisition apparatus;
inputting of at least one distance-of-travel value into the acquisition apparatus by an input device;
adjustment of the power tool from a first operating mode having at least a first operating characteristic value into a second operating mode having at least a second operating characteristic value;
acquisition of at least a second distance value within a predetermined period of time;
transmission of at least one signal from the acquisition apparatus to the power tool in dependence on the acquired at least second distance value; and
adjustment of the power tool from the second operating mode into a third operating mode having at least a third operating characteristic value after a predetermined signal has been received.

14: The method as recited in claim 13 wherein the adjustment of the power tool from the first operating mode having at least the first operating characteristic value into the second operating mode having at least the second operating characteristic value takes place in dependence on at least one characteristic value of a material to be machined.

15: The method as recited in claim 13 wherein the adjustment of the power tool from the first operating mode having at least the first operating characteristic value into the second operating mode having at least the second operating characteristic value takes place in dependence on the length of the distance of travel.

16: The method as recited in claim 13 wherein the adjustment of the power tool from the first operating mode having at least the first operating characteristic value into the second operating mode having at least the second operating characteristic value takes place in dependence on a diameter of a borehole to be produced by the power tool.

17: The method as recited in claim 13 wherein the transmission of the at least one signal from the acquisition apparatus to the power tool in dependence on the acquired at least second distance value takes place either directly from the acquisition apparatus to the power tool or by an external apparatus.

18: The method as recited in claim 13 wherein the third operating mode corresponds to a deactivated state of the power tool.

19: The method as recited in claim 13 wherein a tool of the power tool is operated in a first rotation direction in the first or second operating mode and in a second rotation direction in the third operating mode.

20: The method as recited in claim 13 wherein the operating characteristic values of the power tool is a rotation speed value or torque value.

21: An acquisition apparatus for performing the method as recited in claim 13 comprising at least one sensor, a control device, an interface device and a communication device.

22: The acquisition apparatus as recited in claim 21 wherein the acquisition apparatus is detachably connectable to the power tool.

23: The acquisition apparatus as recited in claim 21 wherein the acquisition apparatus is fixedly connected to the power tool.

24: A system comprising:
a power tool and an acquisition apparatus for performing the method as recited in claim 13,
the power tool including at least a power tool interface and the acquisition apparatus including at least an interface device, wherein the power tool interface and the interface device are able to be fixedly or detachably connected together.
